(19) United States
(12) Patent Application Publication
(10) Pub. No.: US 2023/0103265 A1
(43) Pub. Date: Mar. 30, 2023

(54) AUTOMATED STAFFING PROFILE DISTRIBUTION WITH MULTI-VARIABLE OPTIMIZATION

(71) Applicant: NICE LTD., Ra'anana (IL)

(72) Inventors: Kalyani CHENNUPATI, Coppell, TX (US); Chetan PRAJAPATI, Richardson, TX (US); Thi CAO, Richardson, TX (US); Raji MULUPURI, Richardson, TX (US); Brent HAFERKAMP, Richardson, TX (US)

(21) Appl. No.: 17/489,386

(22) Filed: Sep. 29, 2021

(51) Int. Cl. G06Q 10/06; G06T 11/20

(52) U.S. Cl. CPC G06Q 10/063118; G06T 11/206; G06Q 10/063112; G06F 3/04842

(57) ABSTRACT

Methods of determining optimal staffing distributions include receiving input, wherein the input includes a first workforce constraint and a second workforce constraint; identifying a plurality of values for the first workforce constraint; determining, for each identified value for the first workforce constraint, a combination of the plurality of agent groups that provide the identified value for the first workforce constraint; selecting, for each identified value for the first workforce constraint, a combination of the plurality of agent groups from the determined combinations, that provides an optimal value for the second workforce constraint; generating an optimal line; displaying the optimal line on a graphical user interface; receiving a selection of a point on the optimal line; and applying the selected point to a staffing distribution plan.

### TECHNICAL FIELD

The present disclosure relates generally to determining staffing distributions in workforce management systems, and more specifically to systems and methods for determining optimal staffing distributions based on multiple variables.

### BACKGROUND

Methods for forecasting, planning, and analysis for contact processing centers, also known as call centers, are important for increasing the efficiency of contact processing centers. Workforce management (WFM) is an integrated set of processes that a company uses to optimize the productivity of its employees. For example, WFM includes applications that enable contact center management to forecast workloads and align staffing needs around those forecasts. WFM involves effectively forecasting labor requirements and creating and managing staff schedules to accomplish a particular task on a day-to-day and hour-to-hour basis.

WFM planning products typically tell a company how much staff they need, i.e., full time equivalent (FTE)/agents. Most products, however, do a poor job of handling different staffing profiles (i.e., groups of similar agent types) within an operation. Each staffing profile may have different hourly rates, quality scores, or attrition rates. This typically requires that the company determine the best staffing distribution while considering multiple input variables. Moreover, this all typically requires manual calculation and iteration in conjunction with outputs from typical WFM products.

Accordingly, a need exists for improved systems and methods for determining optimal staffing distributions within a WFM product.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a networked environment suitable for implementing the methods described herein according to various aspects of the present disclosure.

FIG. 2 is a flowchart of a method according to embodiments of the present disclosure.

FIG. 3 is an exemplary decision diagram of algorithms used in the method of FIG. 2, according to embodiments of the present disclosure.

FIG. 4 illustrates the input provided by WFM planner on a graphical user interface, according to embodiments of the present disclosure.

FIG. 5 illustrates an exemplary optimal line on a graphical user interface, according to embodiments of the present disclosure.

FIG. 6 illustrates an exemplary graph on a graphical user interface, according to embodiments of the present disclosure.

FIG. 7 illustrates the input and generated results for a first example on a graphical user interface, according to embodiments of the present disclosure.

FIG. 8 illustrates an exemplary graph showing the results for the first example on a graphical user interface, according to embodiments of the present disclosure.

FIG. 9 illustrates the input and generated results for a second example on a graphical user interface, according to embodiments of the present disclosure.

FIG. 10 illustrates an exemplary graph showing the results for the second example on a graphical user interface, according to embodiments of the present disclosure.

FIG. 11 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein provide a solution integrated within the WFM planning product, e.g., for a WFM center. The present disclosure provides an interface for a WFM planner to provide inputs and constraints, for example, a plurality of hourly rate, quality scores, attrition percent, total agents, and minimum/maximum number of agents per group to determine an optimal staffing distribution given the constraints. As used herein “WFM planner” is a person using a WFM product having administrative privileges for the WFM product so that he or she can create agent staffing profiles and run a forecaster/scheduler.

Once this information is provided by the WFM planner, the present methods automatically calculate and display via a graph and/or a chart, the potential choices of agent groups with an optimal line being displayed. In various embodiments, the graph and/or the chart show the optimal mix of different types of agent groups, and show the mix and related data for minimum, average, and maximum points on the optimal line given various constraints, as well as one or more user selected choices. By “agent group” is meant a group of agents having similar constraints (e.g., hourly rate, quality score, or attrition rate). With this automation, the present systems and methods can minimize or even eliminate manual complex calculations and iterations. Each such manual calculation or iteration is subject to human error in user input or calculation, in addition to the time and resources required. Thus, the present systems vastly increase the efficiency of WFM planning products.

The present disclosure permits a user (e.g., a WFM planner) to quickly and easily determine the range of optimal staffing options based on multiple inputs and constraints. The solution design is to provide summary charts to allow the user to quickly and easily determine an optimal staffing distribution (between agent groups, between sites, between agent groups within a site, etc.). Advantageously, the present methods and systems can result in overall cost savings, which improves contact center quality, and lowers labor costs using an efficient automatic process. The WFM planning product operates more efficiently as well, as manual determinations are minimized so that a graphical representation of optimal outcomes can be developed faster and with fewer or no errors.

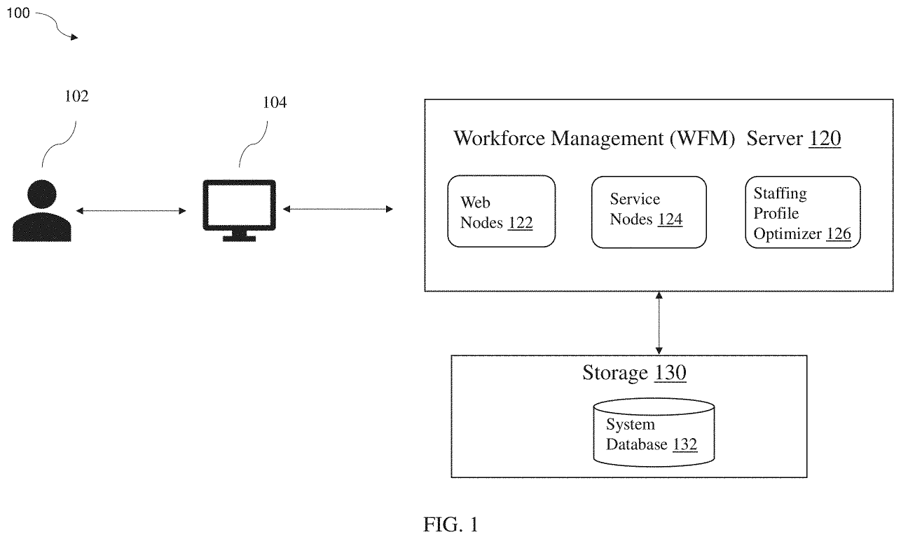

FIG. 1 is a block diagram of a networked environment 100 suitable for implementing the methods described herein according to an embodiment. As shown, environment 100 may include or implement a plurality of devices, servers, and/or software components that operate to perform various methodologies in accordance with the described embodiments. Exemplary devices and servers may include device, stand-alone, and enterprise-class servers, operating an operating system (OS) such as a MICROSOFT® OS, a UNIX®OS, a LINUX®OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, cloud-based architectures have been developed to improve collaboration, integration, and community-based cooperation between users without sacrificing data security. One or more devices and/or servers may be operated and/or maintained by the same or different entities.

FIG. 1 illustrates a block diagram of an example environment 100 according to some embodiments. Environment 100 may include WFM planner client 104 and WFM server 120 for determining optimal staffing distributions. A WFM planner client 104 may be any machine or system that is used by a WFM planner 102 to determine optimal staffing distributions. For example, WFM planner client 104 can be a handheld computing device, a mobile phone, a laptop computer, a notepad computer, a work station, and/or a network of computing devices. As illustrated in FIG. 1, WFM planner client 104 might interact via a network with WFM server 120.

WFM planner client 104 may be utilized in order to provide inputs/constraints to generate an optimal line for determining a staffing distribution plan. In an exemplary embodiment, for a given constraint combination, WFM server 120 generates a graph showing the lowest cost optimal and sub-optimal points, the highest quality optimal and sub-optimal points, and an optimal line that shows the optimal point for each combination.

WFM planner client 104 also typically utilizes one or more user interface devices, such as a keyboard, mouse, trackball, touch pad, touch screen, pen or the like, for interacting with a graphical user interface (GUI) provided by the browser on a display (e.g., a monitor screen, liquid crystal display (LCD) monitor, light emitting diode (LED) monitor, organic light emitting diode (OLED) monitor, etc.) in conjunction with pages, forms, applications, and other information provided by the WFM server 120 or other systems or servers through the web-based or rich client. For example, the user interface device can be used to access data and applications hosted by WFM server 120, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

WFM planner client 104 might communicate with WFM server 120 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. In an example where HTTP/HTTPS is used, client 104 might include an HTTP/HTTPS client commonly referred to as a “browser” for sending and receiving HTTP//HTTPS messages to and from an HTTP//HTTPS server, such as WFM server 120. Such an HTTP/HTTPS server might be implemented as the sole network interface between WFM planner client 104 with WFM server 120, but other techniques might be used as well or instead. In some implementations, the interface between WFM planner client 104 and WFM server 120 may include load sharing functionality.

WFM planner client 104 may utilize a network to communicate with WFM server 120, which may be any network or combination of networks of devices that communicate with one another. For example, the network can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global network often referred to as the Internet. However, it should be understood that the networks that the present embodiments might use are not so limited, although TCP/IP is a frequently implemented protocol.

According to one embodiment, WFM server 120 is configured to provide webpages, forms, applications, data, and media content to WFM planner client 104 and/or to receive data from WFM planner client 104. As such, WFM server 120 provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, WFM server 120, shown in FIG. 1, executes web nodes 122, service nodes 124, and staffing profile optimizer 126. For example, in one embodiment, WFM server 120 includes application servers configured to implement and execute software applications as well as provide related data, code, forms, webpages, and other information associated with web nodes 122, service nodes 124, and staffing profile optimizer 126, and to store to, and retrieve from, a database system related data, objects, and web page content associated with web nodes 122, service nodes 124, and staffing profile optimizer 126. For example, WFM server 120 may implement various functions of web nodes 122, service nodes 124, and staffing profile optimizer 126, and the processing space for executing system processes, such as running applications as part of web nodes 122, service nodes 124, and staffing profile optimizer 126.

Web nodes 122 may correspond to the web applications and API services that provide an interface (web browser, desktop application, etc.) for WFM planner 102 to interact with WFM server 120. Service nodes 124 may provide business services of WFM server 120 that are provided through web nodes 122 and are accessible through WFM planner 102. Staffing profile optimizer 126 receives staffing data from WFM planner 102, generates an optimal graph for WFM planner 102 to pick an optimal point, and applies the optimal point to the staffing distribution plan. In various embodiments, the graph shows optimal and suboptimal points. The WFM planner 102 can select optimal points on the optimal graph and evaluate the selected optimal points. The WFM planner 102 then decides on the final optimal point so it can be applied to the plan. In one embodiment, the WFM planner 102 applies the finalized optimal point to a specific plan of choice automatically (e.g., makes use of a plan updater service).

Several elements in the system shown in FIG. 1 include elements that are explained briefly here. For example, WFM planner client 104 could include a desktop personal computer, workstation, laptop, notepad computer, PDA, cell phone, or any wireless access protocol (WAP) enabled device or any other computing device capable of interfacing directly or indirectly to the Internet or other network connection. Each of WFM planner client 104 typically runs an HTTP/HTTPS client, e.g., a browsing program, such as Microsoft's Internet Explorer or Chromium browser, Google's Chrome browser, Apple's Safari browser, Netscape's Navigator browser, Opera's browser, or a WAP-enabled browser in the case of a cell phone, notepad computer, PDA or other wireless device, or the like. According to one embodiment, WFM planner client 104 and all of its components are configurable using applications, such as a browser, including computer code run using a central processing unit such as an Intel Pentium® processor or the like. Similarly, WFM server 120 and all of its components might be operator configurable using application(s) including computer code to run using a central processing unit, which may include an Intel Pentium® type processor or the like, and/or multiple processor units. The same or different processors may be used for various aspects of the present disclosure. A computer program product embodiment includes a machine-readable storage medium (media) having instructions stored thereon/in which can be used to program a computer to perform any of the processes of the embodiments described herein utilizing one or more computing devices.

Computer code for operating and configuring WFM server 120 to intercommunicate and to process webpages, applications and other data and media content as described herein are preferably downloaded and stored on a hard disk, but the entire program code, or portions thereof, may also be stored in any other volatile or non-volatile memory medium or device corresponding by storage, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. For example, storage 130 may store system database 132 associated with providing and administering WFM server 120, web nodes 122, and/or service nodes 124. Additional data may further be stored by storage 130. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

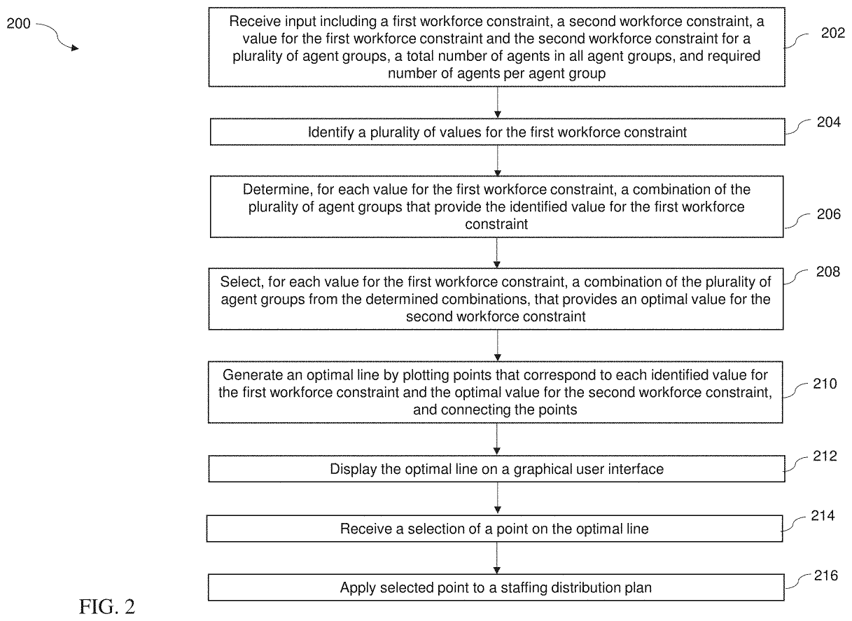

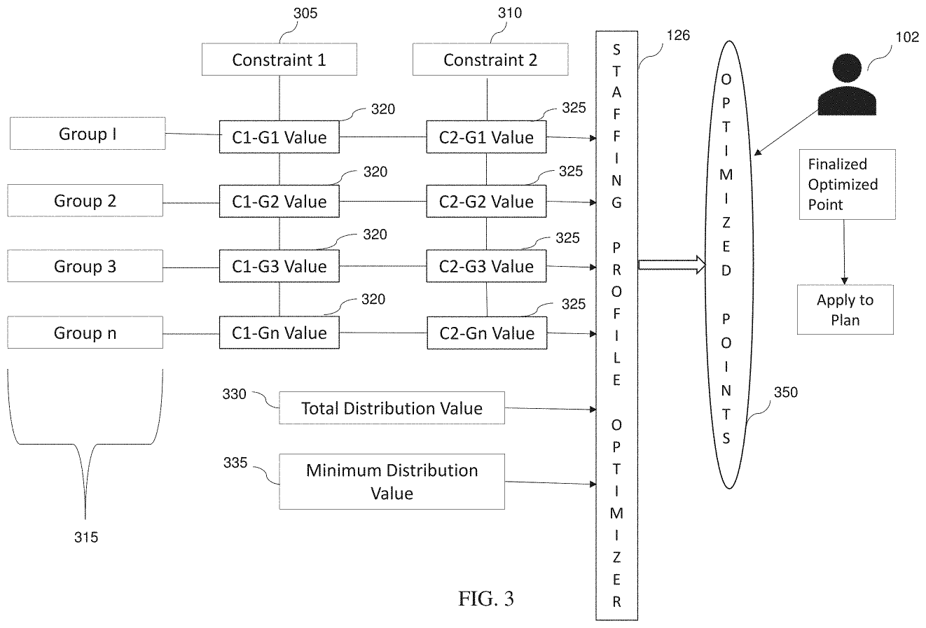

Referring now to FIGS. 2 and 3, a method 200 according to embodiments of the present disclosure is described. At step 202, WFM server 120 receives input from for example, a WFM planner 102. The WFM planner 102 sets up the input to include a first workforce constraint 305, a second workforce constraint 310, a value 320 for the first workforce constraint 305, a value 325 for the second workforce constraint 310 for each of a plurality of agent groups 315, a total number of agents in all agent groups 330, and a required minimum number of agents per agent group 335. Each agent group has a different value for the first workforce constraint 305 and the second workforce constraint 310. In various embodiments, the first workforce constraint 305 and the second workforce constraint 310 include an hourly rate, an overtime rate, a quality score, an attrition percent, a staff shrinkage, a customer satisfaction score, an employee engagement score, an error rate, a productivity percent, or any combination thereof.

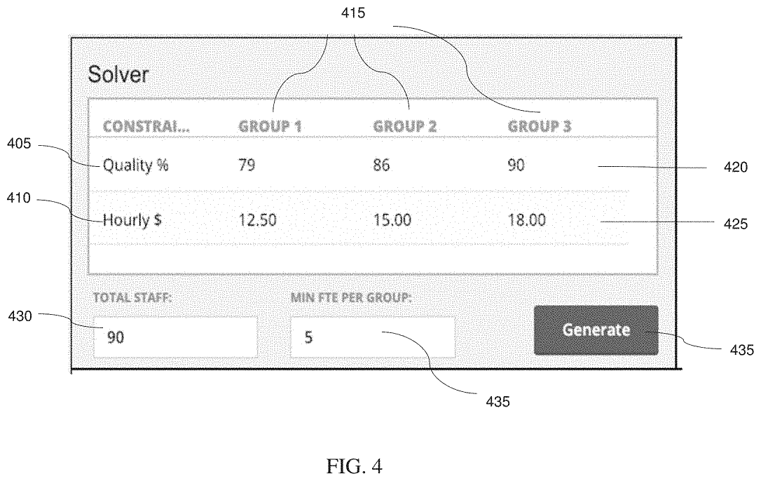

FIG. 4 illustrates the input received by WFM server 120 from WFM planner 102. The input includes a first workforce constraint of quality score or quality percent 405, a second workforce constraint of hourly rate 410, values 420 for the first workforce constraint 405, values 425 for the second workforce constraint 410 for each of a plurality of agent groups 415, a total number of agents in all agent groups 430, and a required minimum number of agents per agent group 435. Once all these inputs are provided, WFM planner 102 can click on the “generate” button 435.

At step 204, WFM server 120 identifies a plurality of values 320 for the first workforce constraint 305. For example, if the first workforce constraint 305 is an hourly rate, a plurality of values for the hourly rate could range from $15/hour to $20/hour (or other currency/time unit), or any other selected range that may be based on prevailing wage rates in a given city, region, or jurisdiction.

At step 206, WFM server 120 determines, for each identified value for the first workforce constraint 305, a combination of the plurality of agent groups 315 that provide the identified value for the first workforce constraint 305, in view of the total number of agents 330 and the required minimum number of agents per agent group 335.

At step 208, WFM server 120 selects, for each identified value for the first workforce constraint, a combination of the plurality of agent groups 315 from the determined combinations, that provides an optimal value for the second workforce constraint 310.

For example, WFM server 120, via staffing profile optimizer 126, identifies all the staffing options that have the same quality score or quality percent (e.g., same customer satisfaction score or CSAT). From this sub-set of staffing options, staffing profile optimizer 126 chooses the option that has the lowest cost (e.g., hourly rate). In particular, for one quality score, staffing profile optimizer 126 comes up with multiple combinations of agents from the different agent groups 315, taking into account the total number of agents 330 and the minimum number of agents per agent group 335. Each of these different combinations of agents will have a cost associated with it, which is based on the hourly rate of each agent group 315. Using all these combinations of agents and the costs, staffing profile optimizer 126 chooses the combination that has the lowest cost for that quality score. In another embodiment, the selection might be the lowest cost combined with that quality score and one or more of the following workforce constraints: a given category of employee, a given level of employee experience, or shift availability.

In another example, WFM server 120, via staffing profile optimizer 126, identifies all the staffing options that have the same cost (e.g., hourly rate). From this sub-set of staffing options, staffing profile optimizer 126 chooses the option that has the highest quality (e.g., CSAT). For one cost, staffing profile optimizer 126 comes up with multiple combinations of agents from different agent groups 315, taking into account the total number of agents 330 and the minimum number of agents per agent group 335. Each of these different combinations of agents will have a quality score associated with it, which is based on the quality score for each agent group 315. Using all these combinations of agents and the quality scores, staffing profile optimizer 126 chooses the combination that has the highest quality for that cost.

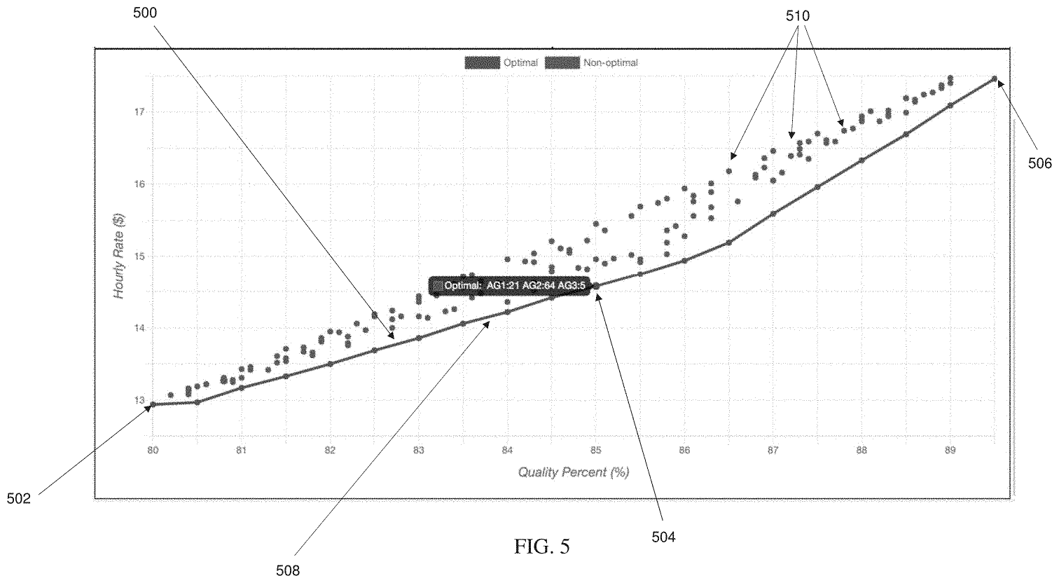

In some embodiments, WFM server 120 also selects, for each identified value for the first workforce constraint 305, a combination of the plurality of agent groups 315 from the determined combinations that provides a sub-optimal value for the second workforce constraint 310, plots points that correspond to each identified value 320 for the first workforce constraint 305 and the sub-optimal value for the second workforce constraint 310, and displays the plotted points for the sub-optimal values next to the optimal line. Referring now to FIG. 5, points 510 correspond to sub-optimal or non-optimal values.

At step 210, WFM server 120 generates an optimal line by plotting optimized points 350 that correspond to each identified value for the first workforce constraint 305 and the optimal value for the second workforce constraint 310, and connecting the points 350. Referring back to FIG. 5, an optimal line 500 is shown where the first workforce constraint is quality percent or quality score and the second workforce constraint is hourly rate. In various embodiments, the optimal line 500 includes a median optimal point 504 that corresponds to a median value for the first workforce constraint 305 and a median value for the second workforce constraint 310. In certain embodiments, at least one of the plurality of points on the optimal line 500 includes one or more of (1) a point on the optimal line that corresponds to a lowest value 502 of the first workforce constraint or the second workforce constraint, (2) a point on the optimal line 500 that corresponds to a highest value 506 of the first workforce constraint or the second workforce constraint, (3) a point on the optimal line 500 that corresponds to a median value 504 for the first workforce constraint and a median value for the second workforce constraint, or (4) a selected point 508 on the optimal line 500. For example, in FIG. 5, point 504, which corresponds to an agent grouping of 21 agents in group 1, 64 agents in group 2, and 5 agents in group 3 is the grouping of agents for the median value for hourly rate and quality percent.

At step 212, WFM server 120 displays the optimal line 500 on a graphical user interface, as shown in FIG. 5.

At step 214, WFM server 120 receives a selection of a point on the optimal line 500 from a user (e.g., WFM planner 102). At step 216, WFM server 120 applies the selected point to a staffing distribution plan.

In several embodiments, WFM server 120 generates a graph illustrating a distribution of agent groups for at least one of a plurality of points on the optimal line 500. In some embodiments, WFM server 120 also calculates a cost associated with the least one of the plurality of points on the optimal line 500. In certain embodiments, WFM server 120 displays the cost on the graph. In various embodiments, WFM server 120 receives a selection of a point on the graph, and displays a cost associated with the selected point on the graph.

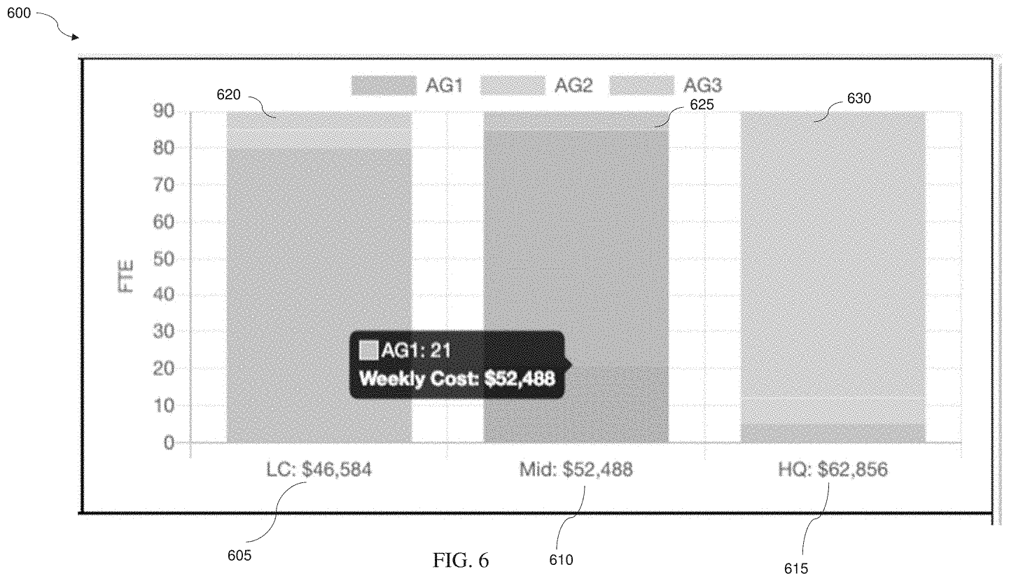

FIG. 6 illustrates an exemplary graph 600 that may be generated by WFM server 120 via staffing profile optimizer 126. The graph 600 provides the costs 605 associated with the lowest cost point 502 on the optimal line 500, the costs 610 associated with the median or mid-point 504 on the optimal line 500, and the costs 615 associated with the highest quality point 506 on the optimal line 500. As shown, WFM planner 102 has selected a point on the graph associated with the median point 504, and a total cost associated with the median point 504 is displayed.

Each bar in the graph 600 shows the distribution of agents for that point. For example, the lowest cost optimized point bar 620 shows how many agents are needed to get the lowest cost optimized point 502. The highest quality optimized point bar 630 shows how many agents from each group are required for the highest quality optimized point 506, and the median or mid cost-mid quality optimized point bar 625 shows how many agents from each group are required for the median or mid-cost mid-quality optimized point 504. Each bar also shows the total costs 605, 610, 615 associated with those optimized points. Upon viewing the graph 600, WFM planner 102 can decide what works best for their staffing solution.

A specific example of the method 200 will now be described in detail.

Input Provided to Staffing Profile Optimizer 126:

1. Workforce constraints of quality percent and hourly rate

2. Three agent groups—AG1, AG2, and AG3, each agent group with a quality percent/score and an hourly rate

3. The total number of agents/staff to be considered

4. The minimum number of FTE/agents/staff expected to be picked from each group

Output Generated by Staffing Profile Optimizer 126:

1. Sub-optimal points. For each quality percent/score, the sub-optimal points were various combinations of groups of agents that were higher cost. Each sub-optimal point gave the number of agents from each agent group that made that point. Each sub-optimal point also gave the costs associated with the point based on the number of agents from each group and the hourly rate of each group.

2. Optimal points. For each quality percent/score, the optimal points were one combination of groups of agents that had the lowest costs. Each optimal point gave the number of agents from each agent group that that made point. Each optimal point also gave the costs associated with the point based on the number of agents from each agent group and the hourly rate of each group.

3. Optimal line—a line that connects all optimal points.

4. Low cost optimized point (LC OP)—the point in the optimized line that has the lowest cost combination of agents from the agent groups.

5. Low cost optimized point (LC OP) cost—cost associated with the point in the optimized line that has the lowest cost combination of agent groups.

6. High quality optimized point (HQ OP)—the point in the optimized line that has the highest quality combination of agent groups.

7. High quality optimized point (HQ OP) cost—cost associated with the point in the optimized line that has the highest quality combination of agent groups.

8. Mid/Median optimal point—a mid-point along the optimal line where the combination of agent groups gives median costs for median quality scores.

9. Mid/Median optimal point cost—cost associated with the median point along the optimal line where the combination of agent groups gives median costs for median quality scores.

10. Selected optimal point—user selected point along the optimal line.

11. Selected optimal point cost—cost associated with user selected point along the optimal line.

Tables 1 and 2 below provide the results of two tests that were run.

TABLE 1
RESULTS OF TWO TESTS

| | | | | | Total | Min FTE | |
|---|---|---|---|---|---|---|---|
| | Constraint | AG 1 | AG 2 | AG 3 | Staff | per group | LC OP |
| Run 1 | Quality % | 79% | 86% | 90% | 90 | 5 | AG1: 80 |
| | | | | | | | AG2: 5 |
| | | | | | | | AG3: 5 |
| | Hourly Rate $ | $12.50 | $15.00 | $18.00 | | | |
| Run 2 | Quality % | 81% | 85% | 90% | 135 | 5 | AG1: 125 |
| | | | | | | | AG2: 5 |
| | | | | | | | AG3: 5 |
| | Hourly Rate $ | $13.25 | $17.00 | $19.75 | | | |

TABLE 2
MORE RESULTS OF TWO TESTS

| | LC OP | | HQ OP | Mid | Mid OP | Selected | Selected |
|---|---|---|---|---|---|---|---|
| | Costs $ | HQ OP | Costs | Optimal Pt | Costs | OP | OP Costs |
| Run 1 | 46,584 | AG1: 5 | 62,856 | AG1: 21 | 52,488 | AG1: 27 | 51,912 |
| | | AG2: 7 | | AG2: 64 | | AG2: 58 | |
| | | AG3: 78 | | AG3: 5 | | AG3: 5 | |
| Run 2 | 73,602 | AG1: 11 | 103,248 | AG1: 71 | 87,642 | AG1: 56 | 91,530 |
| | | AG2: 5 | | AG2: 5 | | AG2: 5 | |
| | | AG3: 119 | | AG3: 59 | | AG3: 74 | |

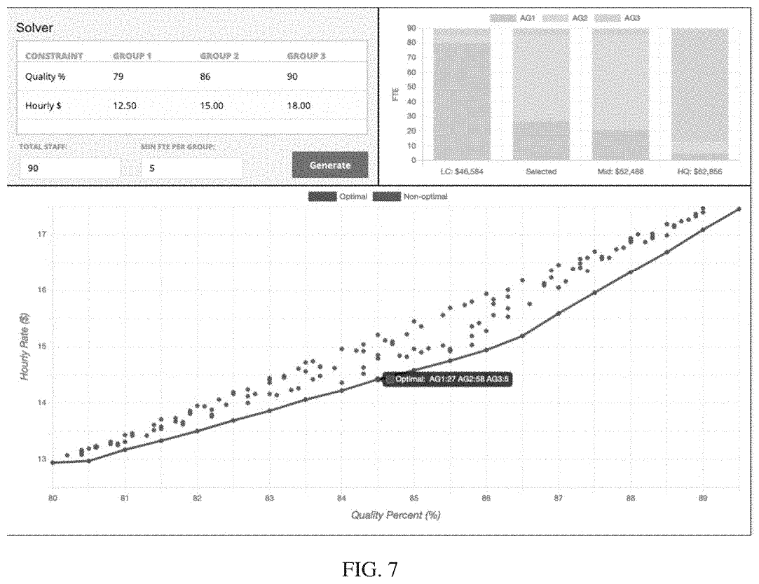

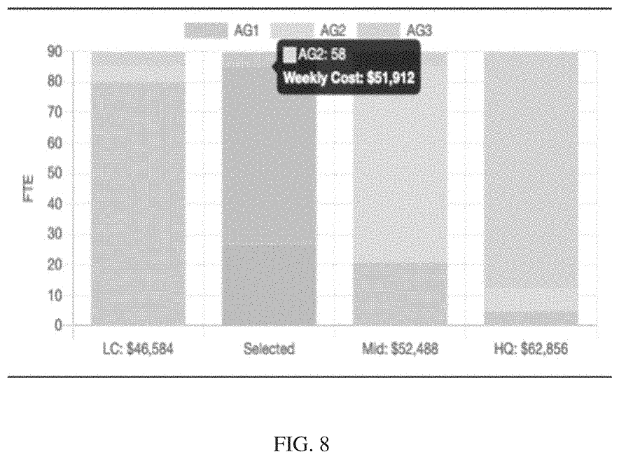

FIG. 7 shows the input and results of Run 1. The selected optimal point in FIG. 7 is shown as having the following agent group combination: AG1: 27, AG2: 58, and AG 3: 5. FIG. 8 is the graph in FIG. 7 showing the weekly cost associated with having 58 agents in agent group 2 (along with 27 agents in group 1 and 5 agents in group 3).

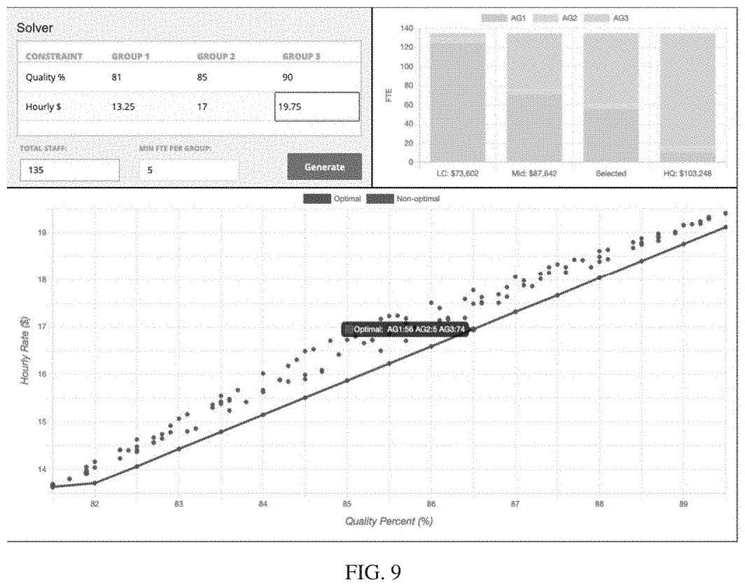

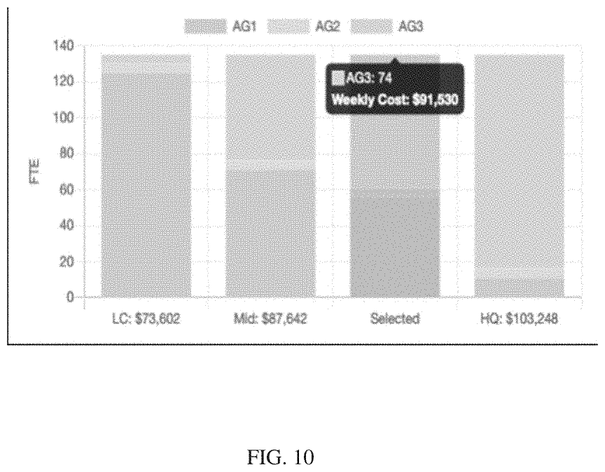

FIG. 9 shows the input and results of Run 2. The selected optimal point is shown as having the following agent group combination: AG1: 56, AG2: 5, and AG3: 74. FIG. 10 is the graph in FIG. 9 showing the weekly cost associated with having 74 agents in agent group 3 (along with 56 agents in group 1 and 5 agents in group 2).

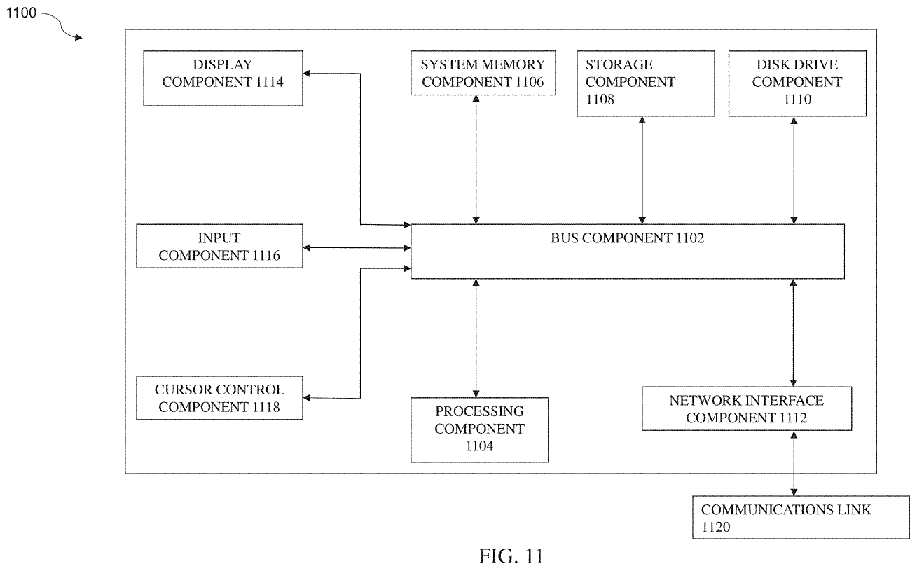

Referring now to FIG. 11, illustrated is a block diagram of a system 1100 suitable for implementing embodiments of the present disclosure, including WFM planner client 104 and WFM servicer 120. System 1100, such as part a computer and/or a network server, includes a bus 1102 or other communication mechanism for communicating information, which interconnects subsystems and components, including one or more of a processing component 1104 (e.g., processor, micro-controller, digital signal processor (DSP), etc.), a system memory component 1106 (e.g., RAM), a static storage component 1108 (e.g., ROM), a network interface component 1112, a display component 1114 (or alternatively, an interface to an external display), an input component 1116 (e.g., keypad or keyboard), and a cursor control component 1118 (e.g., a mouse pad).

In accordance with embodiments of the present disclosure, system 1100 performs specific operations by processor 504 executing one or more sequences of one or more instructions contained in system memory component 506. Such instructions may be read into system memory component 1106 from another computer readable medium, such as static storage component 1108. These may include instructions to receive input, wherein the input includes a first and a second workforce constraint; identify a plurality of values for the first workforce constraint; determine, for each identified value for the first workforce constraint, a combination of the plurality of agent groups that provide the identified value for the first workforce constraint; select, for each identified value for the first workforce constraint, a combination of the plurality of agent groups from the determined combinations, that provides an optimal value for the second workforce constraint; generate an optimal line by plotting points that correspond to each identified value for the first workforce constraint and the optimal value for the second workforce constraint, and connecting the points; display the optimal line on a graphical user interface; receive a selection of a point on the optimal line; and apply the selected point to a staffing distribution plan.

In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1104 for execution. Such a medium may take many forms, including but not limited to, non-volatile media, volatile media, and transmission media. In various implementations, volatile media includes dynamic memory, such as system memory component 1106, and transmission media includes coaxial cables, copper wire, and fiber optics, including wires that comprise bus 1102. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1100. In various other embodiments, a plurality of systems 1100 coupled by communication link 1120 (e.g., LAN, WLAN, PTSN, or various other wired or wireless networks) may perform instruction sequences to practice the disclosure in coordination with one another. Computer system 1100 may transmit and receive messages, data, information and instructions, including one or more programs (i.e., application code) through communication link 1120 and communication interface 1112. Received program code may be executed by processor 1104 as received and/or stored in disk drive component 1110 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A workforce management (WFM) system comprising:
a processor and a computer readable medium operably coupled thereto, the computer readable medium comprising a plurality of instructions stored in association therewith that are accessible to, and executable by, the processor, to perform operations which comprise:
receiving input, wherein the input comprises:
(a) a first workforce constraint,
(b) a second workforce constraint,
(c) a value for the first workforce constraint and the second workforce constraint for each of a plurality of agent groups, wherein each agent group has a different value for the first workforce constraint and the second workforce constraint;
(d) a total number of agents in all agent groups, and
(e) a required minimum number of agents per agent group;
identifying a plurality of values for the first workforce constraint;
determining, for each identified value for the first workforce constraint, a combination of the plurality of agent groups that provide the identified value for the first workforce constraint, in view of the total number of agents and the required minimum number of agents per agent group;
selecting, for each identified value for the first workforce constraint, a combination of the plurality of agent groups from the determined combinations, that provides an optimal value for the second workforce constraint;
generating an optimal line by plotting points that correspond to each identified value for the first workforce constraint and the optimal value for the second workforce constraint, and connecting the points;
displaying the optimal line on a graphical user interface;
receiving a selection of a point on the optimal line; and
applying the selected point to a staffing distribution plan.

2. The WFM system of claim 1, wherein the first workforce constraint and the second workforce constraint comprise an hourly rate, an overtime rate, a quality score, an attrition percent, a staff shrinkage, a customer satisfaction score, an employee engagement score, an error rate, a productivity percent, or a combination thereof.

3. The WFM system of claim 1, wherein the operations further comprise:
selecting, for each identified value for the first workforce constraint, a combination of the plurality of agent groups from the determined combinations that provides a sub-optimal value for the second workforce constraint;
plotting points that correspond to each identified value for the first workforce constraint and the sub-optimal value for the second workforce constraint; and
displaying the plotted points for the sub-optimal values next to the optimal line.

4. The WFM system of claim 1, wherein the optimal line comprises a median optimal point that corresponds to a median value for the first workforce constraint and a median value for the second workforce constraint.

5. The WFM system of claim 1, wherein the operations further comprise generating a graph illustrating a distribution of agent groups for at least one of a plurality of points on the optimal line.

6. The WFM system of claim 5, wherein at least one of the plurality of points on the optimal line comprises one or more of:
(a) a point on the optimal line that corresponds to a lowest value of the first workforce constraint or the second workforce constraint;
(b) a point on the optimal line that corresponds to a highest value of the first workforce constraint or the second workforce constraint;
(c) a point on the optimal line that corresponds to a median value for the first workforce constraint and a median value for the second workforce constraint; or
(d) the selected point on the optimal line.

7. The WFM system of claim 5, wherein the operations further comprise calculating a cost associated with the at least one of the plurality of points on the optimal line.

8. The WFM system of claim 7, wherein the operations further comprise displaying the cost on the graph.

9. The WFM system of claim 5, further comprising receiving a selection of a point on the graph, and displaying a cost associated with the selected point on the graph.

10. A method of determining optimal staffing distributions, which comprises:
receiving input, wherein the input comprises:
(a) a first workforce constraint,
(b) a second workforce constraint,
(c) a value for the first workforce constraint and the second workforce constraint for each of a plurality of agent groups, wherein each agent group has a different value for the first workforce constraint and the second workforce constraint;
(d) a total number of agents in all agent groups, and
(e) a required minimum number of agents per agent group;
identifying a plurality of values for the first workforce constraint;
determining, for each identified value for the first workforce constraint, a combination of the plurality of agent groups that provide the identified value for the first workforce constraint, in view of the total number of agents and the required minimum number of agents per agent group;
selecting, for each identified value for the first workforce constraint, a combination of the plurality of agent groups from the determined combinations, that provides an optimal value for the second workforce constraint;
generating an optimal line by plotting points that correspond to each identified value for the first workforce constraint and the optimal value for the second workforce constraint, and connecting the points;
displaying the optimal line on a graphical user interface;
receiving a selection of a point on the optimal line; and
applying the selected point to a staffing distribution plan.

11. The method of claim 10, wherein the first workforce constraint and the second workforce constraint comprise an hourly rate, an overtime rate, a quality score, an attrition percent, a staff shrinkage, a customer satisfaction score, an employee engagement score, an error rate, a productivity percent, or a combination thereof.

12. The method of claim 10, further comprising:
selecting, for each identified value for the first workforce constraint, a combination of the plurality of agent groups from the determined combinations that provides a sub-optimal value for the second workforce constraint;
plotting points that correspond to each identified value for the first workforce constraint and the sub-optimal value for the second workforce constraint; and
displaying the plotted points for the sub-optimal values next to the optimal line.

13. The method of claim 10, further comprising generating a graph illustrating a distribution of agent groups for at least one of a plurality of points on the optimal line.

14. The method of claim 13, wherein at least one of the plurality of points on the optimal line comprises one or more of:
(a) a point on the optimal line that corresponds to a lowest value of the first workforce constraint or the second workforce constraint;
(b) a point on the optimal line that corresponds to a highest value of the first workforce constraint or the second workforce constraint;
(c) a point on the optimal line that corresponds to a median value for the first workforce constraint and a median value for the second workforce constraint; or
(d) the selected point on the optimal line.

15. The method of claim 13, further comprising calculating a cost associated with the at least one of the plurality of points on the optimal line, and displaying the cost on the graph.

16. A non-transitory computer-readable medium having stored thereon computer-readable instructions executable by a processor to perform operations which comprise:
receiving input, wherein the input comprises:
(a) a first workforce constraint,
(b) a second workforce constraint,
(c) a value for the first workforce constraint and the second workforce constraint for each of a plurality of agent groups, wherein each agent group has a different value for the first workforce constraint and the second workforce constraint;
(d) a total number of agents in all agent groups, and
(e) a required minimum number of agents per agent group;
identifying a plurality of values for the first workforce constraint;
determining, for each identified value for the first workforce constraint, a combination of the plurality of agent groups that provide the identified value for the first workforce constraint, in view of the total number of agents and the required minimum number of agents per agent group;
selecting, for each identified value for the first workforce constraint, a combination of the plurality of agent groups from the determined combinations, that provides an optimal value for the second workforce constraint;
generating an optimal line by plotting points that correspond to each identified value for the first workforce constraint and the optimal value for the second workforce constraint, and connecting the points;
displaying the optimal line on a graphical user interface;
receiving a selection of a point on the optimal line; and
applying the selected point to a staffing distribution plan.

17. The non-transitory computer-readable medium of claim 16, wherein the operations further comprise:
selecting, for each identified value for the first workforce constraint, a combination of the plurality of agent groups from the determined combinations that provides a sub-optimal value for the second workforce constraint;
plotting points that correspond to each identified value for the first workforce constraint and the sub-optimal value for the second workforce constraint; and
displaying the plotted points for the sub-optimal values next to the optimal line.

18. The non-transitory computer-readable medium of claim 16, wherein the operations further comprise generating a graph illustrating a distribution of agent groups for at least one of a plurality of points on the optimal line.

19. The non-transitory computer-readable medium of claim 18, wherein at least one of the plurality of points on the optimal line comprises one or more of:
(a) a point on the optimal line that corresponds to a lowest value of the first workforce constraint or the second workforce constraint;
(b) a point on the optimal line that corresponds to a highest value of the first workforce constraint or the second workforce constraint;
(c) a point on the optimal line that corresponds to a median value for the first workforce constraint and a median value for the second workforce constraint; or
(d) the selected point on the optimal line.

20. The non-transitory computer-readable medium of claim 18, wherein the operations further comprise calculating a cost associated with the at least one of the plurality of points on the optimal line, and displaying the cost on the graph.
